(19) United States
(12) Patent Application Publication
(10) Pub. No.: US 2025/0216210 A1
(43) Pub. Date: Jul. 3, 2025

(54) Optimizing Provision of Traffic Flow Simulations for Representation of Real-Time Traffic Conditions

(71) Applicant: Google LLC, Mountain View, CA (US)

(72) Inventors: Omar Galal El Sheikh, Boulder, CO (US); Sitian Chen, Vancouver (CA)

(21) Appl. No.: 18/622,289

(22) Filed: Mar. 29, 2024

Related U.S. Application Data
(60) Provisional application No. 63/616,704, filed on Dec. 31, 2023.

(51) Int. Cl. G01C 21/34; G01C 21/36

(52) U.S. Cl. CPC G01C 21/3492; G01C 21/3638; G01C 21/367; G01C 21/3691

(57) ABSTRACT

Request information is obtained from a user computing device, wherein the request information is indicative of a request to provide simulation information for one or more transportation segments within a geographic area. Traffic information indicative of a current and/or predicted degree of traffic for each of the one or more transportation segments within the geographic area is obtained. Based on the traffic information, one or more pre-generated traffic animations are respectively selected for the one or more transportation segments, wherein, for each of the one or more pre-generated traffic animations, the pre-generated traffic animation is indicative of traffic conditions associated with the current and/or predicted degree of traffic within a corresponding transportation segment of the one or more transportation segments. Simulation information descriptive of the one or more pre-generated traffic animations for the one or more transportation segments is provided to the user computing device.

### PRIORITY CLAIM

The present application claims priority to, and the benefit of, U.S. Provisional Patent Application No. 63/616,704, having a filing date of Dec. 31, 2023. Applicant incorporates the application herein by reference in its entirety.

### FIELD

The present disclosure relates generally to traffic flow simulation. More particularly, the present disclosure relates to simulating traffic flow within a representation of a transportation segment based on real-time traffic information.

### BACKGROUND

Some applications, such as mapping applications, visual search applications, etc. include features for providing navigation instructions to users. Such navigation instructions are generally provided by displaying a top-down view of a map, and highlighting a series of navigation infrastructure (e.g., roads, highways, etc.) that collectively navigate from a starting location to a desired location. In some instances, current and/or predicted traffic levels can substantially affect the estimated travel time for a route. As such, some navigation applications will indicate the current/predicted degree of traffic currently occurring in a transportation segment. For example, a transportation segment with a high degree of current/predicted traffic may be highlighted red, while another transportation segment with a low degree of current/predicted traffic may be highlighted blue.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining, by a computing system comprising one or more computing devices, request information from a user computing device, wherein the request information is indicative of a request to provide simulation information for one or more transportation segments within a geographic area. The method includes, responsive to receiving the request information, obtaining, by the computing system, traffic information indicative of a current and/or predicted degree of traffic for each of the one or more transportation segments within the geographic area. The method includes, based on the traffic information, respectively selecting, by the computing system, one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments. The method includes providing, by the computing system, the simulation information for the one or more transportation segments to the user computing device, wherein the simulation information is descriptive of the one or more pre-generated traffic animations.

Another example aspect of the present disclosure is directed to a computing system that includes one or more processors and one or more non-transitory computer-readable media that store instructions that, when executed by the one or more processors, cause the computing system to perform operations. The operations include obtaining request information from a user computing device, wherein the request information is indicative of a request to provide simulation information for one or more transportation segments within a geographic area. The operations include, responsive to receiving the request information, obtaining traffic information indicative of a current and/or predicted degree of traffic for each of the one or more transportation segments within the geographic area. The operations include, based on the traffic information, respectively selecting one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments. The operations include providing the simulation information for the one or more transportation segments to the user computing device, wherein the simulation information is descriptive of the one or more pre-generated traffic animations.

Another example aspect of the present disclosure is directed to one or more non-transitory computer-readable media that store instructions that, when executed by one or more processors, cause the one or more processors to perform operations. The operations include obtaining request information from a user computing device, wherein the request information is indicative of a request to provide simulation information for one or more transportation segments within a geographic area. The operations include, responsive to receiving the request information, obtaining traffic information indicative of a current and/or predicted degree of traffic for each of the one or more transportation segments within the geographic area. The operations include, based on the traffic information, respectively selecting one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments. The operations include providing the simulation information for the one or more transportation segments to the user computing device, wherein the simulation information is descriptive of the one or more pre-generated traffic animations.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs enablement of realistic traffic simulation based on real-world conditions according to example embodiments of the present disclosure.

FIG. 1B depicts a block diagram of an example computing device that performs pre-generated traffic animation rendering according to example embodiments of the present disclosure.

FIG. 1C depicts a block diagram of an example computing device that performs keyframe data generation and/or model training according to example embodiments of the present disclosure.

FIG. 2 is a block diagram of an example computing system for optimizing provision of traffic flow simulations for representation of real-time traffic conditions according to some implementations of the present disclosure.

FIG. 3 is a block diagram of an example user computing device for optimizing provision of traffic flow simulations for representation of real-time traffic conditions according to some implementations of the present disclosure.

FIG. 4 depicts an example user input applied to a map representation of a particular geographic area within a navigation application according to some implementations of the present disclosure.

FIG. 5 depicts an example top-down view of animated vehicle objects traversing a three-dimensional representation of a transportation segment according to some implementations of the present disclosure.

FIG. 6 depicts an example view of a three-dimensional representation of a transportation segment in which animated vehicle objects traverse the transportation segment according to some implementations of the present disclosure.

FIG. 7 depicts a flow chart diagram of an example method to optimize provision of traffic flow simulations for representation of real-time traffic conditions according to example embodiments of the present disclosure.

Reference numerals that are repeated across plural figures are intended to identify the same features in various implementations.

### DETAILED DESCRIPTION

### Overview

Generally, the present disclosure is directed to simulating traffic flow within a Three-Dimensional (3D) representation of a geographic area based on real-time traffic information. For example, a pre-generated traffic animation for a transportation segment within a 3D simulation of New York City can be populated with simulated objects (e.g., vehicles, pedestrians, etc.). The rate at which the animation depicts objects traversing the transportation segment (e.g., road, highway, alley, sidewalk, pedestrian crossing, business, interior area, public area, flight path, naval path, river, trail, etc.) can be based on current/predicted traffic conditions. The density of the simulated vehicles can correspond to real-time traffic information to provide a realistic depiction of real-time traffic conditions. In this manner, users can make more nuanced decisions when planning routes.

More specifically, conventional navigation applications can indicate traffic with color-coding transportation infrastructure. For example, a road with heavy traffic is color coded red, medium traffic is yellow, etc. However, this approach can lack specificity, as “red” traffic could mean completely impassible traffic or a temporary accident. In addition, it is difficult for users to visualize what traffic would look like in a geographic area. By providing a realistic depiction of current and predicted traffic, users can make more informed transportation decisions.

As such, implementations described herein enable generation and provision of pre-generated traffic animations of transportation segments with varying levels of traffic. These pre-generated traffic animations can be selected and provided to user devices for display to a user within a 3D representation of the transportation segment based on real-time traffic data. For example, for Times Square in New York City, pre-generated traffic animations can be generated that depicts objects navigating Times Square (e.g., vehicles, pedestrians, etc.) in accordance with a light degree of traffic (e.g., relatively few objects traversing the segment), a medium degree of traffic (e.g., more objects traversing the segment), and a heavy degree of traffic (e.g., relatively many objects traversing the segment). In some implementations, the pre-generated traffic animations can be provided directly to the user device, while in other implementations, information descriptive of the pre-generated traffic animations can be provided to the user device. For example, rather than providing the animations, keyframe information can instead be provided to the user device, and the user device can leverage the keyframe information to locally display the pre-generated traffic animations.

Additionally, in some implementations, additional pre-generated traffic animations can be generated for the segment for type of rendering (e.g., light, medium, and heavy traffic) that each depict a different weather condition. For example, multiple pre-generated traffic animations can be generated and stored that depict vehicles traversing the segment in accordance with a heavy degree of traffic during rain conditions, snow conditions, sunny conditions, etc. In this manner, user immersion can be enhanced further by closely mirroring real-world conditions experienced by the user.

Aspects of the present disclosure provide a number of technical effects and benefits. As one example technical effect and benefit, the implementations described herein enable more efficient utilization of local device processing resources. More specifically, many conventional simulation implementations generate simulations and then render video using the simulations. This video is stored and then transmitted to user devices for display when needed. However, these approaches necessitate the use of substantial storage resources, network bandwidth, compute cycles, etc. while the resources at the user device go unused. As such, by providing keyframe data to enable local on-device rendering, implementations described can substantially reduce the expenditure of resources associated with conventional simulation approaches while more efficiently utilizing available distributed compute resources. Another example benefit of the present disclosure is enabling users to make more informed transportation decisions. More specifically, by visualizing current and predicted traffic patterns in a realistic manner, implementations described herein provide sufficient specificity to enable users to select more efficient transportation options.

A “pre-generated” animation, as described herein, generally refers to animation information that has been at least partially generated at a remote system and provided to a computing device for the purposes of reducing the computational resources required to render an animated simulation at the computing device. More specifically, a pre-generated traffic animation can refer to the output(s) of any (or all) tasks performed to render and animate a simulated and animated traffic environment. Because the pre-generated traffic animation may also include information utilized for rendering tasks, the pre-generated traffic animation may include some (or all) of the information necessary to render the animation, such as rendering assets, instructions for a rendering engine, etc. In some implementations, a pre-generated traffic animation may include animation-specific information, such as keyframes, objects selected for rendering/animation, animation scripts for specific objects or portion(s) of object(s), etc.

Additionally, or alternatively, in some implementations, a pre-generated traffic animation may include “pre-baked” rendering assets, such as textures, meshes, models, implicit representation information (e.g., generated using a Neural Radiance Field (NeRF) model, shadow information, normals data, specular data, etc. A “pre-baked” asset generally refers to the encoding of pre-computed information into an asset for the purposes of optimizing the subsequent rendering of that asset. In other words, if information must be computed for an asset prior to rendering, a pre-baked asset can be generated by pre-computing the information and including the pre-computed information within (or alongside) the asset. Additionally, or alternatively, in some implementations, the pre-generated traffic animation can include simulation assets or information, such as environmental simulations (e.g., a simulated representation of a particular city environment, etc.), weather information, etc.

It should be noted that the processing performed to generate the pre-generated traffic animation can vary based on various conditions, such as the processing resources available to a computing device, or the rendering software available to the computing device. Additionally, in some implementations, the task(s) performed by a computing system when generating the pre-generated traffic animation can be modified dynamically based on various conditions (e.g., current network bandwidth, available processing resources, software compatibility, etc.).

For example, if the computing system provides the pre-generated traffic animation to a computing device with access to processing resources sufficient to locally render lighting (e.g., a Graphics Processing Unit (GPU) or similar), the computing system may refrain from “pre-baking” lighting information into the pre-generated traffic animation. Conversely, if the computing system provides the pre-generated traffic animation to a computing device that does not have access to processing resources for local lighting rendering tasks, the computing system may pre-bake the lighting information into the pre-generated traffic animation to reduce the processing to be performed by the computing device.

In addition, the size of the pre-generated traffic animation can vary substantially based on the processing performed to generate the pre-generated traffic animation (e.g., a pre-generated traffic animation that only includes information indicating placement and animation instructions for rendered objects would be substantially smaller than a pre-generated traffic animation that also includes rendering assets (e.g., textures, meshes, etc.).

With reference now to the Figures, example embodiments of the present disclosure will be discussed in further detail.

### Example Devices and Systems

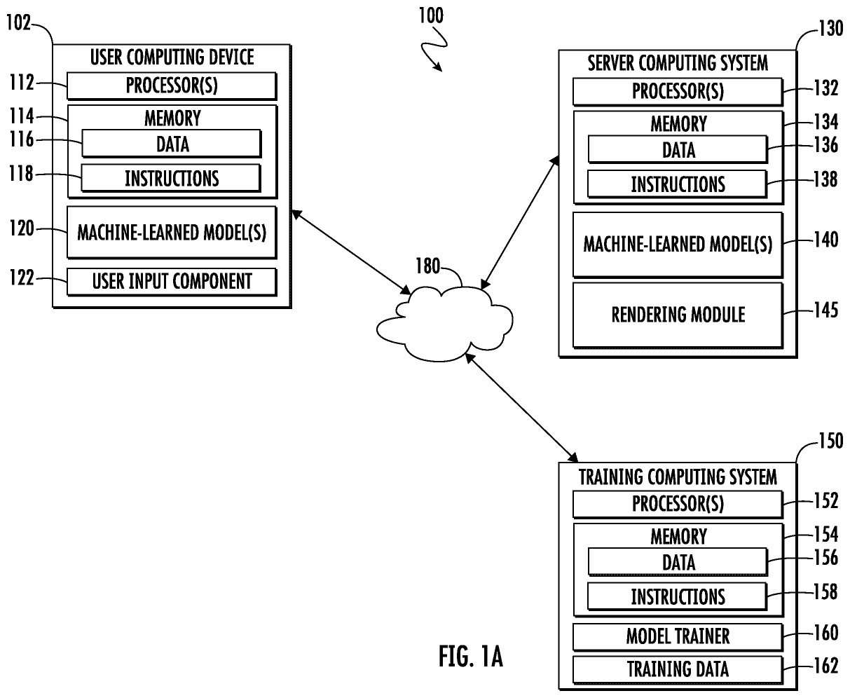

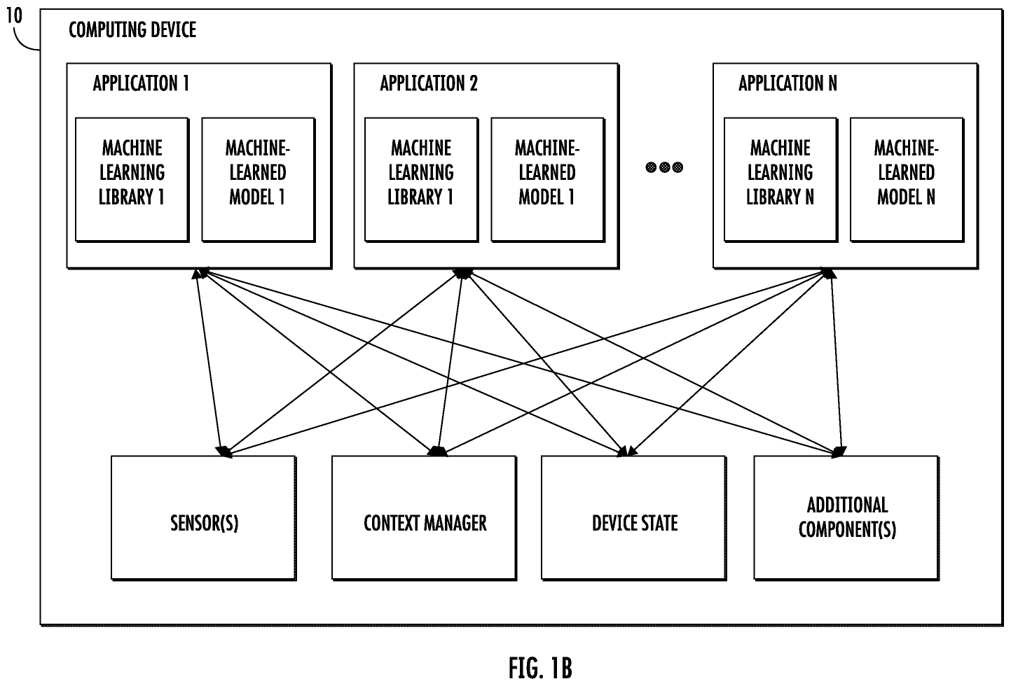

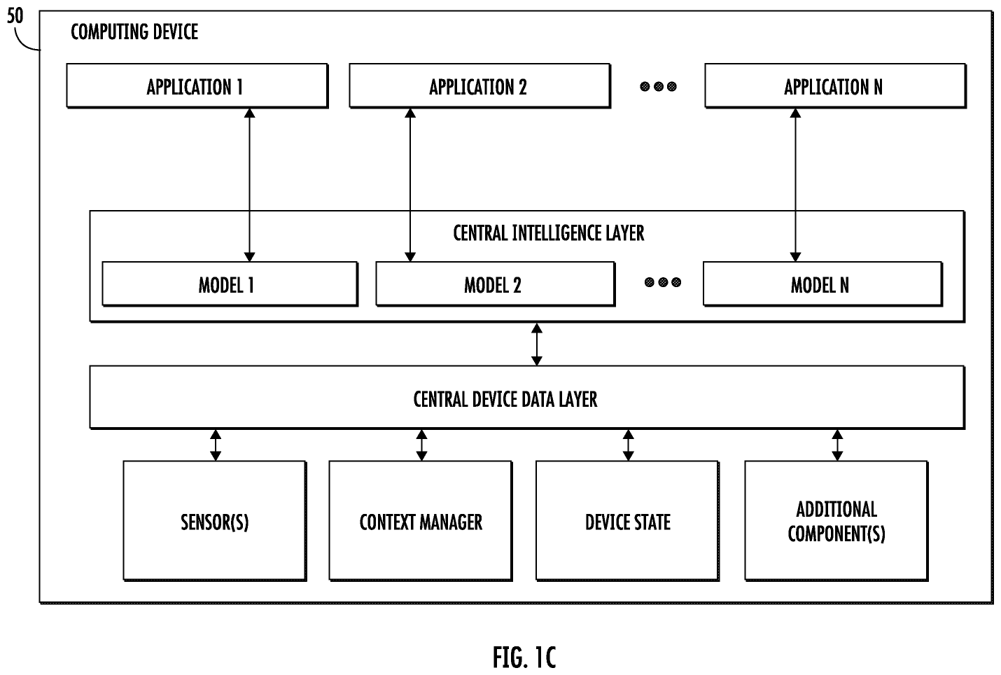

FIG. 1A depicts a block diagram of an example computing system 100 that performs enablement of realistic traffic simulation based on real-world conditions according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

Additionally or alternatively, one or more models 140 can be included in or otherwise stored and implemented by the server computing system 130 that communicates with the user computing device 102 according to a client-server relationship. For example, the models 140 can be implemented by the server computing system 130 as a portion of a web service (e.g., a navigation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the machine-learned models 140 can be models for generating animations of traffic conditions for a transportation segment. For example, the machine-learned models 140 can be, or include, implicit representation models (e.g., Neural Radiance Field (NeRF) models, etc.) that can generate implicit representations of geographic areas. The machine-learned models 140 can be leveraged to generate pre-generated traffic animations of multiple types of traffic conditions for specific transportation segments.

In some implementations, the server computing system 130 can include a rendering module 145. The rendering module 145 can render pre-generated traffic animations for transportation segments, and can store and index the pre-generated traffic animations. For example, assume that five transportation segments exist for a geographic area. For each of the five transportation segments, the rendering module 145 can generate three pre-generated traffic animations of vehicles traversing the transportation segment at a low degree of traffic, a medium degree of traffic, and a high degree of traffic respectively. Additionally, or alternatively, in some implementations, multiple animations can be generated for each degree of traffic to depict varying weather conditions. For example, for one of the five transportation segments, the rendering module 145 can generate a set of low-traffic animations, a set of medium-traffic animations, and a set of high-traffic animations. Each set of traffic animations can include animations depicting varying weather conditions. For example, the set of low-traffic animations can include a first animation in which vehicles traverse the transportation segment at a rate associated with a low degree of traffic while it snows, and a second animation in which vehicles traverse the transportation segment at a rate associated with a low degree of traffic while it rains.

In some implementations, the rendering module 145 can generate simulation information descriptive of the pre-generated simulations, and can provide the simulation information to the user computing device 102. In some implementations, the simulation information can include the pre-generated traffic animations. For example, the simulation information can include video data that depicts the pre-generated traffic animations. For another example, the rendering module 145 can stream the simulation information to the user computing device 102. Alternatively, in some implementations, the simulation information can be utilized by the user computing device 102 to render, or display, the pre-generated traffic animations. For example, assume that the user computing device 102 includes a rendering engine. The simulation information can include the traffic information. The user computing device 102 can render vehicles traversing the transportation segment based on the traffic information. For example, the user computing device 102 may instantiate a vehicle creation function or object that causes vehicles to “spawn” or instantiate and begin traversing a transportation segment from a particular location. The number of vehicle creation functions instantiated by the user computing device can vary based on the traffic information, with a greater number of vehicle creation functions being instantiated for higher degrees of traffic.

Alternatively, in some implementations, the simulation information can include any other type or manner of asset, instructions, etc. utilized for partial or full rendering of the pre-generated traffic animation at the user computing device 102. For example, the simulation information can include textures and information for rendering the transportation segment itself, while the user computing device 102 may already store textures and software instructions for rendering vehicles and other objects traversing the transportation segment. For another example, the simulation information can include textures and information for rendering the objects traversing the transportation segment, while the user computing device 102 may already store textures and software instructions for rendering the transportation segment. For another example, the simulation information can include information indicating a type and/or number of vehicles to render, while the user computing device 102 may already store textures and software instructions for rendering vehicles, other objects, and the transportation segment itself.

In some implementations, the user computing device 102 can display, or cause display of, a pre-generated traffic animation based on a user input. For example, assume that the user computing device 102 executes a navigation or mapping application that depicts a top-down “map” view of an area. The application can allow the user to move or “zoom” a viewpoint (e.g., a top-down view) closer or further away from a particular transportation segment. If the user moves the viewpoint “closer” to the particular transportation segment past a particular threshold degree of closeness, the user computing device 102 can display the pre-generated traffic animation for the segment. If the user moves subsequently moves the viewpoint “further” from the particular transportation segment, the user computing device 102 can cease playback of the pre-generated traffic information. In this manner, the pre-generated traffic animation can provide a more detailed and accurate representation of current traffic conditions to assist the user in route planning and other analogous tasks in a time-efficient manner.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training data 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs pre-generated traffic animation rendering according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs keyframe data generation and/or model training according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

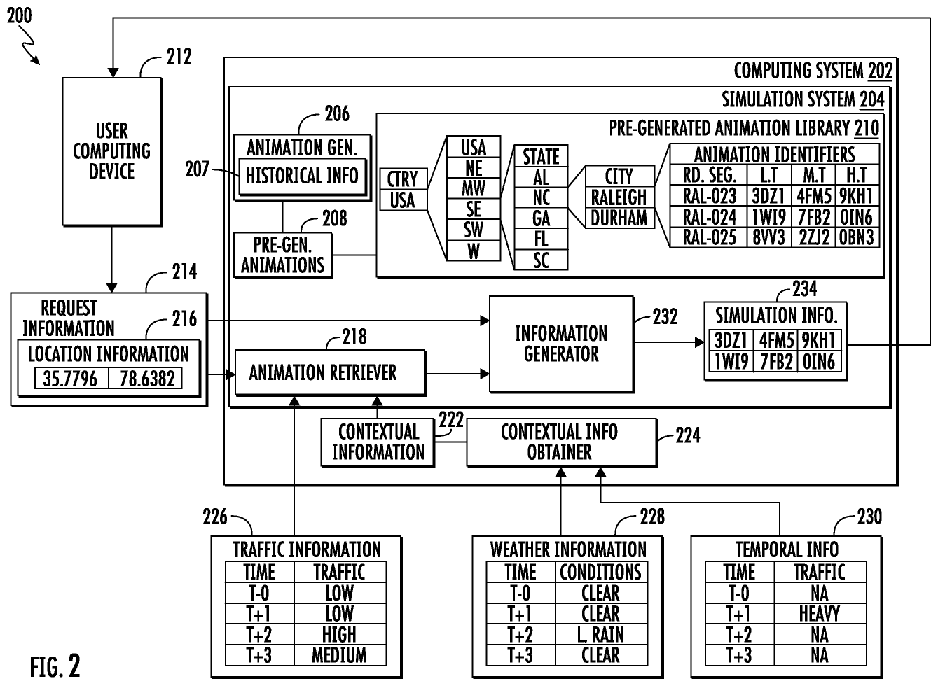

FIG. 2 is a block diagram 200 of an example computing system for optimizing provision of traffic flow simulations for representation of real-time traffic conditions according to some implementations of the present disclosure. More specifically, computing system 202 can be a system (e.g., a cloud-based system, a virtualized system, a distributed computing system, etc.) associated with particular application(s) that provide simulation features for users. For example, the computing system 202 may be associated with an application (e.g., a mapping application, a visual search application, etc.) that implements simulation features (e.g., simulated traffic flow within a mapping application, etc.).

To do so, the computing system 202 can include a simulation system 204. The simulation system 204 can be a system that performs pre-computing tasks to enable remote computing devices to perform simulations. More specifically, the simulation system 204 can, in some implementations, generate pre-generated traffic animations to be utilized to animate traffic conditions within a simulated transportation segment. For example, assume that the computing system 202 is associated with a mapping application that simulates real-time traffic conditions within a particular transportation segment. The simulation can include simulated vehicles traversing the particular transportation segment. The pre-generated traffic animation generated by the simulation system 204 can indicate a number of simulated vehicles, type(s) of simulated vehicles, animation instructions for the simulated vehicles, etc.

As described herein, a transportation segment generally refers to some portion of transportation infrastructure that is traversable by a user. For example, a transportation segment may refer to a segment of a road, highway, hiking trail, ski trail, toll route, sidewalk, bridge, train track, aerial transportation route, etc. In addition, a “segment” of a road can be demarcated using any type or manner of navigation process. For example, a road in a large city may be segmented on a per-city-block basis, while a rural highway road may be segmented on a per-exit basis, per-mile basis, etc.

The simulation system 204 can include an animation generator 206. The animation generator 206 can be used to at least partially generate pre-generated traffic animations 208 for specific transportation segments. The pre-generated traffic animations 208 can be stored to pre-generated traffic animation library 210. The pre-generated traffic animation library 210 can store any type or manner of pre-generated traffic animation or portion of a pre-generated traffic animation (e.g., textures, animation scripting, etc.). In some implementations, the pre-generated traffic animation library 210 can index the pre-generated traffic animation for retrieval based on simulation requests received from user devices. To follow the depicted example, assume that a user computing device located in Raleigh North Carolina requests pre-generated traffic animations for a local simulation task. The simulation system 204 can index the pre-generated traffic animations 208 by location within the pre-generated traffic animation library 210. Based on the request received from the user computing device, the simulation system can efficiently retrieve the pre-generated traffic animations 208 that correspond to the location of the user computing device.

As described previously, the pre-generated traffic animations 208 can be, or otherwise include, animation information that has been at least partially generated at the computing system 202 for subsequent provision to computing devices for the purposes of reducing the computational resources required to render an animated simulation at the computing devices. More specifically, the pre-generated traffic animations 208 can be, or otherwise include, the output(s) of any (or all) tasks performed to simulate an animated traffic environment. Because the pre-generated traffic animations 208 may also include information utilized for rendering tasks, the pre-generated traffic animations 208 may include some (or all) of the information necessary to render the animation, such as rendering assets, instructions for a rendering engine, etc. In some implementations, the pre-generated traffic animations 208 may include animation-specific information, such as keyframes, objects selected for rendering/animation, animation scripts for specific objects or portion(s) of object(s), etc.

Additionally, or alternatively, in some implementations, the pre-generated traffic animations 208 may include “pre-baked” rendering assets, such as textures, meshes, models, implicit representation information (e.g., generated using a Neural Radiance Field (NeRF) model, shadow information, normals data, specular data, etc. A “pre-baked” asset generally refers to the encoding of pre-computed information into an asset for the purposes of optimizing the subsequent rendering of that asset. Additionally, or alternatively, in some implementations, the pre-generated traffic animations 208 can include simulation assets or information, such as environmental simulations (e.g., a simulated representation of a particular city environment, etc.), weather information, etc.

In some implementations, the animation generator 206 can generate multiple pre-generated traffic animations for a specific transportation segment or location to accurately reflect real-time or predicted traffic conditions. For example, given a specific transportation segment, the animation generator 206 may generate a low-traffic animation, a medium-traffic animation, and a heavy traffic animation for the transportation segment. The low-traffic animation can animate a sparse quantity of vehicles traversing a transportation segment, while the high-traffic animation can animate a dense quantity of vehicles traversing the transportation segment. In this manner, an animation that accurately reflects current traffic conditions can be retrieved and delivered to a requesting device with minimal delay.

Additionally, or alternatively, in some implementations, the animation generator 206 can generate multiple pre-generated traffic animations for a specific transportation segment or location to accurately reflect real-time or predicted weather conditions or events. For example, given a specific transportation segment, the animation generator 206 can generate pre-generated traffic animations that animate specific weather effects within the transportation segment (e.g., light rain, heavy rain, snow, fog, etc.). For another example, assume that a series of transportation segments are utilized each year to facilitate a unique event, such as a parade. The animation generator 206 may generate an event-specific animation for the road segment that is visually indicative of the event.

In some implementations, multiple pre-generated traffic animations can be generated to reflect multiple corresponding weather conditions for a particular degree of traffic. For example, the animation generator 206 may generate three low-traffic animations for a transportation segment that depict clear weather, light rain, and heavy rain respectively. The animation generator 206 may further generate three high-traffic animations for the transportation segment that depict clear weather, light rain, and heavy rain respectively.

Alternatively, in some implementations, the animation generator 206 may forego generating weather-specific animations in favor of enabling local rendering of weather effects at the user computing device. For example, rather than generating both “heavy rain/low traffic” and “light rain/low traffic” animation for a transportation segment with the animation generator 206, the simulation system 204 may instruct a requesting user computing device to dynamically render a particular weather effect. In this manner, the simulation system 204 can substantially reduce computational resource expenditure.

Additionally, or alternatively, in some implementations, the simulation system 204 can determine whether to generate multiple pre-generated traffic animations for a specific transportation segment based on historical information 207 for the specific transportation segment. The historical information 207 can indicate previous traffic conditions, probabilities for the occurrence of previous traffic conditions, previous planned events associated with the transportation segment, etc. For example, assume that the historical information 207 indicates that low-traffic and medium-traffic conditions are common for a road segment, and that high-traffic conditions have only occurred once in the past decade. Based on the historical information, the simulation system 204 may determine to generate low-traffic and medium-traffic pre-generated traffic animations and forego generating a high-traffic pre-generated traffic animation.

It should be noted that the processing performed to generate the pre-generated traffic animations 208 can vary based on various conditions, such as the processing resources available to a computing device, or the rendering software available to the computing device. Additionally, in some implementations, the task(s) performed by a computing system when generating the pre-generated traffic animation can be modified dynamically based on various conditions (e.g., current network bandwidth, available processing resources, software compatibility, etc.).

For example, if the computing system provides the pre-generated traffic animation to a computing device with access to processing resources sufficient to locally render lighting (e.g., a Graphics Processing Unit (GPU) or similar), the computing system may refrain from “pre-baking” lighting information into the pre-generated traffic animation. Conversely, if the computing system 202 provides the pre-generated traffic animations 208 to a computing device that does not have access to processing resources for local lighting rendering tasks, the computing system 202 may pre-bake the lighting information into the pre-generated traffic animation to reduce the processing to be performed by the computing device.

In addition, the size of the pre-generated traffic animations 208 can vary substantially based on the processing performed to generate the pre-generated traffic animations 208 (e.g., a pre-generated traffic animation that only includes information indicating placement and animation instructions for rendered objects would be substantially smaller than a pre-generated traffic animation that also includes rendering assets (e.g., textures, meshes, etc.).

A user computing device 212 (e.g., a smartphone, a laptop, a desktop, a Mixed Reality (MR) device, a wearable device, a virtualized device, etc.) can provide request information 214 to the simulation system 204. The request information 214 can be indicative of a request to provide simulation information for one or more transportation segments within a geographic area. In some implementations, the request information 214 can include location information 216. The location information 216 can indicate a current location of the user computing device 212. For example, the location information 216 can include geocoordinates for the last known location of the user computing device 212. In some implementations, the location information 216 can indicate location(s) that the user computing device 212 is planned or predicted to traverse. For example, assume that the user computing device 212 executes a mapping application, and a user of the user computing device inputs a desired destination to the mapping application. The location information 216 can describe or indicate the desired destination, and/or transportation segment(s) planned or predicted for the user to traverse to arrive at the desired destination.

Alternatively, in some implementations, the location information 216 can at least partially be determined by the computing system 202. To follow the previous example, the request information 214 may indicate a desired destination input by the user. In response, the computing system 202 can generate navigation instructions that identify transportation segments for the user to traverse to arrive at the destination. The simulation system 204 can obtain the navigation instructions and can retrieve the pre-generated traffic animations 208 for the identified transportation segments.

In some implementations, the request information 214 can be provided to the simulation system 204 in response to an input received by a user of the user computing device 212. For example, assume that the user computing device executes a mapping application. The mapping application can display a view of two-dimensional top-down map of a geographic area. However, if the user provides an input to magnify, or “zoom in” on the view, the mapping application can transition from displaying the two-dimensional top-down map to displaying a three-dimensional simulation of the particular geographic area, or a transportation segment located within the geographic area. The simulation of the particular geographic area can be animated with pre-generated traffic animations of traffic conditions (e.g., low-traffic, high-traffic, etc.). In other words, the quantity and speed of the vehicles animated traversing the simulation of the geographic area can be specified by, or included in, the pre-generated traffic animation. Upon receipt of the user input to magnify the view, the user computing device 212 can provide the request information to the simulation system 204.

In some implementations, the pre-generated traffic animations 208 can depict, or otherwise animate, non-ground-based vehicles, non-vehicular objects or entities, etc. within the transportation segment. For example, the pre-generated traffic animations 208 may depict crowds of people, aerial vehicles, etc.

The simulation system 204 can include an animation retriever 218. The animation retriever 218 can retrieve the pre-generated traffic animations 208 based on the request information 214 and traffic information 220. The traffic information 220 can be obtained from any internal or external traffic monitoring service. For example, if the computing system 202 is associated with a mapping application, the computing system 202 may monitor the speed of user computing devices executing instances of the mapping application as they traverse through specific transportation segments (e.g., determining an average speed of 15 Miles Per Hour (MPH) for a transportation segment based on reports from user computing devices that traversed the transportation segment within the last 20 minutes, etc.). Alternatively, the computing system 202 may obtain the traffic information 220 from some other source (e.g., a traffic monitoring service, etc.).

The animation retriever 218 can retrieve the pre-generated traffic animations 208 based on the traffic information 220 by retrieving the pre-generated traffic animations 208 that correspond to the current and/or predicted degree of traffic indicated by the traffic information 220. More specifically, the request information 214 can indicate a particular transportation segment to be simulated. In response, the computing system 202 can obtain traffic information 220 that indicates a current or predicted degree of traffic for the transportation segment. The animation retriever 218 can retrieve one of the pre-generated traffic animations 208 that accurately depicts or indicates the current or predicted degree of traffic within the particular transportation segment.

For example, assume that the location information 216 identifies a transportation segment in the downtown area of a major city, and the traffic information 220 indicates that the transportation segment is currently experiencing a high degree of traffic. In response, the animation retriever 218 can retrieve a high-traffic pre-generated traffic animation 208 that has been generated for the particular transportation segment from the pre-generated traffic animation library 210. For another example, assume that the traffic information 220 indicates that the degree of traffic is predicted to imminently change from high-traffic conditions to medium-traffic conditions. In response, the animation retriever 218 can retrieve high-traffic and medium-traffic pre-generated traffic animations for provision to the user computing device 212.

In some implementations, the animation retriever 218 can retrieve the pre-generated traffic animations 208 based on contextual information 222 obtained by a contextual information obtainer 224 of the computing system 202. The contextual information 222 can include any type or manner of contextual information, such as traffic information 226, weather information 228, and temporal information 230. Specifically, the traffic information 226 can indicate current and/or predicted traffic conditions for specific transportation segment(s). To follow the depicted example, the traffic information 226 can indicate that, at a current time T (e.g., T−0) there are low-traffic conditions for the transportation segment, and in three hours (e.g., T+3), high-traffic conditions are predicted. Similarly, the weather information 228 can indicate current and/or predicted weather conditions for specific transportation segment(s). To follow the depicted example, the weather information 228 can indicate that, at a current time T (e.g., T−0), the transportation segment is experiencing clear weather conditions, and in three hours (e.g., T+3), the transportation segment is predicted to experience light rain conditions.

The temporal information 230 can indicate, or describe, planned occurrences that may have some effect on traffic conditions within a particular transportation segment. For example, assume that a road closure is planned for a particular transportation segment. Upon road closure, the absence of speed reports from vehicles traversing the road segment may initially indicate low-traffic conditions. However, the temporal information 230 can indicate that the absence of speed reports is caused by a road closure, rather than a lack of traversing vehicles. In turn, some depiction of the road closure can be simulated and displayed to the user.

As another example, assume that a concert for a popular musician is being held in a stadium located along a particular transportation segment within a city. Further assume that the high-traffic conditions are a common occurrence within the particular transportation segment. Based on initial speed reports received from vehicles traversing the transportation segment, the simulation system 204 may detect the occurrence of conventional high-traffic conditions that commonly occur within the transportation segment. However, based on the concert being identified by the temporal information 230, the simulation system 204 can determine that the concert is likely causative of the high-traffic conditions within the transportation segment.

The determination that the high-traffic conditions are caused by the planned event, rather than the typical causes of high-traffic conditions common to the transportation segment, can be further evaluated based on the traffic conditions detected for nearby transportation segments and/or any other portion of the contextual information 222. For example, if all nearby transportation segments are experiencing low-traffic conditions, the simulation system 204 can determine that the high-traffic conditions are likely caused by the concert. Conversely, if all nearby transportation segments are experiencing similar traffic conditions, and such traffic conditions are common for the current time of day, the simulation system 204 can determine that the concert is less likely to be causative of the current traffic conditions.

In some implementations, the simulation system 204 can determine which of the pre-generated traffic animations 208 to select with the animation retriever 218 based on the contextual information 222. To follow the previous example, if the simulation system 204 determines that the concert event is unlikely to be causative of the high-traffic conditions, the animation retriever 218 can retrieve a conventional high-traffic pre-generated traffic animation that has been generated for the transportation segment. Alternatively, if the simulation system 204 determines that the concert event is likely causative of the high-traffic conditions, the animation retriever 218 can retrieve and modify the high-traffic pre-generated traffic animation to indicate the occurrence of the concert. For example, the animation retriever 218 may coordinate with the animation generator 206 to generate a new pre-generated traffic animation 208 that depicts concert activity within a three-dimensional representation of the stadium in which the concert is occurring. In this manner, the simulation system 204 can efficiently convey additional contextual information to the user if the user computing device 212 so that the user can make more optimal transportation decisions.

The pre-generated traffic animations 208 retrieved by the animation retriever 218 can be provided to an information generator 232 of the simulation system 204. The information generator 232 can generate simulation information 234 based on the request information 214 and the pre-generated traffic animations 208 retrieved by the animation retriever 218. The simulation information 234 can include, describe, or can otherwise be indicative of the pre-generated traffic animation(s) retrieved by the animation retriever 218. For example, assume that one of the pre-generated traffic animations 208 depicts a particular number of vehicles traversing the transportation segment within a particular amount of time. The simulation information 234 may include the pre-generated traffic animation, or may describe the number of vehicles to traverse the transportation segment within the particular amount of time.

More specifically, the simulation information 234 may include the entirety of a pre-generated animation, or may include information sufficient for the user computing device 212 to locally render the pre-generated animation. As such, in some implementations, the granularity and/or type of information included within the simulation information 234 can vary based on the rendering capabilities of the user computing device 212, which can be indicated by the user computing device 212 with the request information 214. The information generator 232 can generate the simulation information 234 based at least in part on the capabilities of the user computing device 212 indicated by the request information 214.

For example, assume that the pre-generated traffic animations 208 are depicted within a three-dimensional representation of the geographic area in which the transportation segment is located (e.g., a three-dimensional representation of a city block, etc.). To locally render the three-dimensional representation of the geographic area, the user computing device 212 may require conventional 3D representation assets (e.g., textures, meshes, etc.), implicit representation assets (e.g., a Neural Radiance Field (NeRF) model trained to implicitly represent the geographic area and/or the outputs of such a model). This asset requirement can be indicated within the request information 214, and in response, the information generator 232 can include the required assets within the simulation information 234. For another example, if the request information 214 indicates that the user computing device 212 lacks sufficient compute power to apply some shading or rendering technique (e.g., ambient occlusion, ray tracing, shadows, anti-aliasing, etc.), the technique can be performed by the simulation system 204, and the output(s) of the technique can be included in or otherwise indicated by the simulation information 234.

In some implementations, the information generator 232 can modify characteristics of the pre-generated traffic animations 208 retrieved by the animation retriever 218 based on the request information 214. For example, assume the request information 214 indicates that the user computing device 212 lacks sufficient compute resources to locally render the pre-generated traffic animations 208. In response, the information generator 232 can downscale or otherwise reduce the visual fidelity of the pre-generated traffic animations 208 such that the compute resources of the user computing device 212 are sufficient to render the downscaled animations. Alternatively, the information generator 232 may generate simulation information 234 that instructs the user computing device 212 to downscale or reduce the visual fidelity of the pre-generated traffic animations 208 prior to (or during) rendering.

The simulation information 234 can be provided to the user computing device 212. The user computing device 212 can utilize the simulation information 234 to locally render and display the pre-generated traffic animations 208. In this manner, the user computing device 212 can display high-quality visual representations of traffic conditions for a user while avoiding delay caused by generating animations, thus providing the user with an additional degree of granularity and context for making navigation decisions.

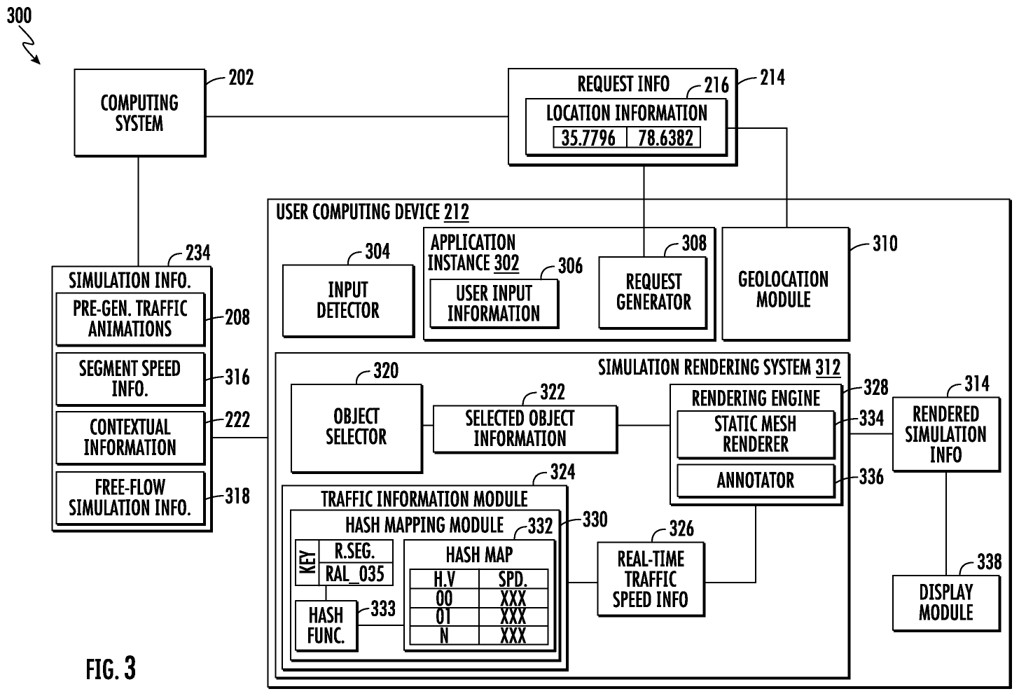

FIG. 3 is a block diagram 300 of an example user computing device for optimizing provision of traffic flow simulations for representation of real-time traffic conditions according to some implementations of the present disclosure. FIG. 3 will be discussed in conjunction with FIG. 2. Specifically, the user computing device 212 can include, implement, or otherwise execute an application instance 302. The application instance 302 can be an instance of an application that provides a real-time traffic simulation feature, such as a navigation application, mapping application, a “super app” that provides multiple features across various fields and use-cases, etc.

The application instance 302 can cause an interface for the application instance 302 to be displayed at a display device associated with the user computing device 212. For example, if the user computing device 212 is a smartphone device, the application instance 302 can display an application interface within an in-built display device of the smartphone device, or a display device communicatively coupled to the user computing device 212 (e.g., a Mixed Reality (MR) head-mounted display device, etc.).

The user computing device 212 can include an input detector 304. In some implementations, the input detector 304 can be implemented by the application instance 302. The input detector 304 can detect and identify user inputs received via a user input device, such as a touch screen, microphone, etc. In particular, the input detector 304 can detect a touch input performed by a user and can classify the touch input from a plurality of candidate touch inputs (e.g., zoom, drag, pinch, etc.). The input detector 304 can determine whether a user input is provided within the interface of the application instance 302 that is displayed by the user computing device 212.

More specifically, the input detector 304 can identify an intent associated with the received user input. In some implementations, to do so, the input detector 304 can perform gesture recognition. For example, the user may place two fingers on a touchscreen and then drag both fingers away from each other while maintaining contact with the touchscreen. In response, the input detector 304 can detect a “zoom” input. For another example, the user may place their fingers in front of themselves and mimic the same “zoom gesture,” or some other gesture. The input detector 304 can receive a visual depiction of the gesture (e.g., captured via an image capture device of the user computing device 212) and can perform a visual recognition process to identify the gesture. The input detector 304 can perform similar processes with regards to audio input, touch input, haptic input, movement tracking input (e.g., eye movement, hand movement, etc.), etc.

The input detector 304 can generate user input information 306. In some implementations, the user input information 306 can classify, describe, or otherwise indicate the type of touch input provided by the user. For example, if the user provides a “zoom” input where the user places two fingers on the screen and slides their two fingers in opposite directions of each other, the user input information 306 can indicate that the user provided a zoom input. Further, in some implementations, the user input information 306 can describe additional characteristics of the received user input (e.g., coordinates for a touch input relative to the touchscreen, a degree of pressure applied to the touchscreen, a travel distance for the touch input, etc.).

The application instance 302 can receive the user input information 306, and based on the identified user input, can determine that the user has requested a simulation of traffic conditions for a particular location. Specifically, in some implementations, the application instance 302 can determine that the user has provided a “zoom” touch input that “zooms in” on an interface of the application instance 302.

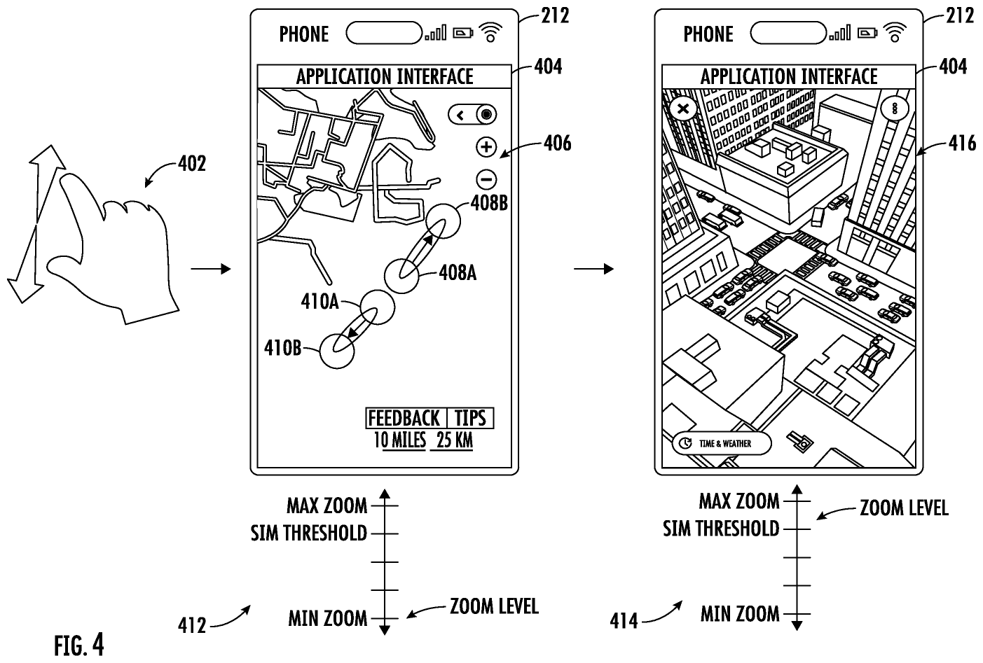

For a more specific example, turning to FIG. 4, FIG. 4 depicts an example user input applied to a map representation of a particular geographic area within a navigation application according to some implementations of the present disclosure. Specifically, a user input 402 can be detected and identified by the input detector 304 of the user computing device 212. As depicted, the user input 402 can be a zoom input applied to a touchscreen device of the user computing device 212. In particular, the user input 402 can be provided at a location of the display device of the user computing device 212 that also displays a map 406 within an application interface 404 of the application instance 302.

To follow the depicted example, the user may provide the user input 402 to a touchscreen device of the user computing device 212 that displays the map 406 within the application interface 404. by placing two fingers at locations 408A and 408B, respectively. The user then may perform a zoom gesture by dragging one finger from location 408A to location 410A, and another finger from location 408B to location 410B, while maintaining contact with the touchscreen device.

As described herein, a “zoom level,” or degree of zoom, generally refers to a degree of magnification being applied to depicted subject matter. As a degree of zoom is increased, the subject matter depicted within the center of the application interface 404 will be depicted as increasingly larger and/or with increasing visual fidelity, while subject matter depicted at the edges of the application interface 404 will cease being depicted and/or will be depicted with decreasing visual fidelity. Conversely, as the degree of zoom is decreased, the subject matter depicted within the center of the application interface 404 will be depicted increasingly larger and/or with increasing visual fidelity.

In the context of navigation applications, maps such as the map 406 are generally depicted from a top-down perspective located a certain distance from the surface of the geographic area being depicted. As such, as the degree of zoom applied to the map 406 is increased, the top-down perspective of the map 406 can move closer to the surface of the geographic area. For example, assume that the map 406 is depicted from a top-down perspective located 200 feet from the surface of the depicted geographic area. If the degree of zoom is increased, the map 406 can be depicted from a top-down perspective less than 200 feet from the surface of the geographic area.

The degree of zoom applied to the map 406 is visually depicted by zoom indicator 412 and 414. The zoom indicators 412 and 414 are depicted to more clearly explain the various implementations described herein, and are not necessarily displayed to the user within the application interface 404. The zoom indicator 412 depicts a current zoom level applied to the application interface 404 prior to receipt of the user input 402. The zoom indicator 414 depicts a zoom level applied to the application interface 404 following receipt of the user input 402.

The zoom level that can be applied to the map 406 ranges from a minimum degree of zoom (e.g., “MIN ZOOM”) to a maximum degree of zoom (e.g., “MAX ZOOM”). As indicated by the zoom indicators 412 and 414, the user input 402 can modify the zoom level of the application interface 404 from a minimum zoom level to a maximum zoom level. The zoom indicators 412 and 414 can also include a simulation threshold. The simulation threshold refers to a threshold zoom level that, if surpassed, can cause a transition from the map 406 to a simulation 416 of the geographic area depicted by the map 406.

More specifically, after a certain degree of magnification of the map 406 (e.g., the simulation threshold), further increases in magnification can lead to diminishing returns with regards to visual fidelity. As such, the application interface 404 can transition from the displaying the top-down view of the map 406 to displaying a simulation 416 that depicts a three-dimensional simulated representation of the geographic area.

It should be noted that the simulation 416 is not only provided in response to a zoom gesture applied to the application interface 404. Rather, the simulation 416 can be provided to a user based on a variety of received user inputs. For example, the user may select an interface element that causes a direct transition to the simulation 416. For another example, the user may provide a voice input describing a request to display the simulation 416, or may perform a gesture associated with display of the simulation 416. For another example, the user may provide a general request for information regarding the geographic area, and in response, the user computing device 212 can provide the simulation 416 alongside other information related to the geographic area (e.g., to provide a search service, a visual search service, etc.).

Returning to FIG. 3, the application instance 302 can determine that the user has requested simulation information for transportation segment(s) within a particular geographic area based on the user input information 306. In response, the application instance 302 can generate the request information 214 using a request generator 308. The request information 214 can request simulation information for the transportation segment(s) as described with regards to FIG. 3. Additionally, in some implementations, the user computing device 212 can include a geolocation module 310. The geolocation module 310 can determine a current location of the user computing device 212 and can include the location information 216 within the request information 214. The computing system 202 can receive the request information 214 and, in response, can provide the simulation information 234 to the user computing device 212.

The user computing device 212 can include a simulation rendering system 312. The simulation rendering system 312 can render a simulation of a particular geographic area. More specifically, the simulation rendering system 312 can at least partially generate, render, or otherwise cause display of rendered simulation information 314 based on the simulation information 234. The rendered simulation information 314 can depict a three-dimensional representation of transportation segments (e.g., roads, sidewalks, crossings, etc.) within a particular geographic area (e.g., a portion of a city, suburbs, etc.). The rendered simulation information 314 can also depict a set of vehicles traversing the three-dimensional representation of transportation segments. The type, quantity, speed, and/or behavior of vehicles included in the set of vehicles can be determined based on the simulation information 234.

In some implementations, the simulation information 234 can include the pre-generated traffic animations 208, or information descriptive of the pre-generated traffic animations 208. Additionally, or alternatively, in some implementations, the simulation information 234 can include segment speed information 316. The segment speed information 316 can indicate an average speed of vehicles traversing the transportation segments. Additionally, or alternatively, in some implementations, the simulation information 234 can include the contextual information 222 as described with regards to FIG. 3. Additionally, or alternatively, in some implementations, the simulation information 234 can include free-flow simulation information 318. The free-flow simulation information 318 can indicate a typical speed, quantity, etc. of vehicles that freely flow through the transportation segments (i.e., traverse the transportation segments without delay caused by traffic).

In some implementations, the simulation rendering system 312 can include an object selector 320. The object selector 320 can select objects to be visually depicted within the rendered simulation information 314. Specifically, the object selector 320 can select types and/or quantities of vehicles to be animated traversing the transportation segments. The object selector 320 can select types and/or quantities of vehicles based on the simulation information 234. For example, assume that the simulation information 234 indicates that the transportation segments are currently experiencing heavy traffic conditions. In response, the object selector 320 can select a quantity of vehicles to be animated traversing the simulated transportation segments that provides a visually accurate representation of the heavy traffic conditions. For another example, assume that simulation information 234 indicates that a particular type of vehicle object is unique to the geographic location of the user computing device 212 (e.g., double-decker busses in London, taxis in New York City, canal boats in Venice, etc.). In response, the object selector 320 can select one or more of the unique vehicle objects for inclusion in the set of vehicle objects.

Additionally, or alternatively, in some implementations, the object selector 320 can select non-vehicle objects to populate the three-dimensional representation of the geographic area depicted by the rendered simulation information 314. Such objects can include pedestrians, cyclists, walkers/runners, wildlife (e.g., birds, etc.), non-ground-based vehicles (e.g., airplanes, helicopters, etc.), transportation infrastructure (e.g., pedestrian bridges, walk signs, traffic lights), advertisements, billboards, signs, etc.

In some implementations, the object selector 320 can determine specific animation characteristics for each object selected for inclusion in the rendered simulation information 314. For example, the object selector 320 may determine a traversal speed for each vehicle object, or may modify a traversal speed indicated by the simulation information 234. Alternatively, the object selector 320 may utilize animation characteristics specified by the simulation information 234.

The object selector 320 can generate selected object information 322. The selected object information 322 can indicate the selected objects to be animated and rendered within the rendered simulation information 314. In some implementations, the simulation rendering system 312 can include, or can otherwise access, a traffic information module 324. The traffic information module 324 can obtain real-time traffic speed information 326, and can provide the real-time traffic speed information 326 to the object selector 320, and/or to a rendering engine 328 included in the simulation rendering system 312. The real-time traffic speed information 326 can indicate a current and/or predicted speed of traffic within the transportation segments.

In some implementations, the traffic information module 324 can include a hash mapping module 330. The hash mapping module 330 can include a hash map 332 that associates transportation segments with real-time transportation segment speeds. The hash mapping module 330 can utilize the hash map 332 to obtain the real-time traffic speed information 326. Specifically, to follow the depicted example, the traffic information module 324 can obtain a key that identifies a particular transportation segment (RAL_035). The hash mapping module 330 can apply a hash function 333 to the key to obtain a hash value. The hash mapping module 330 can perform a search of the hash map 332 to obtain a real-time speed value that corresponds to the hash value, and the real-time speed value can be included in the real-time traffic speed information 326.

In some implementations, the pre-generated traffic animations 208 can include multiple animations for the transportation segments that each animate a different degree of traffic within the transportation segment. The simulation information 234 can indicate a typical speed of traffic for the transportation segments, and the real-time traffic speed information 326 can indicate the current and/or predicted traffic conditions within the transportation segment. Based on the real-time traffic speed information, the simulation rendering system 312 can select one of the multiple pre-generated traffic animations 208 that accurately reflects the real-time traffic speed information 326.

The selected object information 322, the simulation information 234, and/or the real-time traffic speed information 326 can be provided to the rendering engine 328. The rendering engine 328 can perform some, or all, of the tasks necessary to render the rendered simulation information 314. Rendering tasks that the rendering engine 328 does not perform, or cannot perform, can be performed by the computing system 202, and the outputs of such tasks can be included in or otherwise indicated by the simulation information 234.

To follow the depicted example, the rendering engine 328 can include a static mesh renderer 334. The static mesh renderer 334 can perform mesh rendering of objects identified by the selected object information 322. However, the rendering engine 328 may lack the capability, and/or the compute resources necessary, to render a three-dimensional simulation of the environment in which the transportation segments exist (e.g., buildings, pedestrians, the sky, weather, etc.). The simulation information 234 may include a rendering of the environment, pre-generated assets to be included in a rendering of the environment, or some other output(s) of rendering tasks that enable the simulation rendering system to render the environment. It should be noted that, in some implementations, the simulation information 234 can directly include some or all of the rendered simulation information 314. In such instances, the user computing device 212 may forego utilization of the simulation rendering system 312 and directly display the rendered simulation information 314 as received from the computing system 202.

In some implementations, the rendering engine 328 can include an annotator 336. The annotator 336 can annotate the rendered simulation information 314 to provide additional context and supplemental information to the user, such as route-specific traffic annotation markers. For example, assume that one of the transportation segments is experiencing heavy traffic conditions. If the contextual information 222 indicates that the heavy traffic conditions are caused by a local event or some other incident (e.g., a traffic accident, a road closure, a parade, etc.), the annotator 336 can annotate the rendered simulation information with a visual indication of the cause of the heavy traffic conditions (e.g., a “celebration” icon for an event, a musical note icon for a concert, a “collision” icon for an accident, etc.). Conversely, if the heavy traffic is simply rush-hour traffic or is otherwise common within the transportation segment, the annotator 336 may refrain from annotating the rendered simulation information 314.

Additionally, or alternatively, in some implementations, the annotator 336 can annotate the rendered simulation information 314 with textual content. To follow the previous example, assume that the heavy traffic conditions are caused by a concert that ends at 7:30 p.m. The annotator 336 can annotate the rendered simulation information 314 with textual content indicating the 7:30 pm end time for the concert. In this manner, a user can quickly and efficiently make optimal navigation decisions.

The rendering engine 328 can utilize the pre-generated traffic animations 208 to render the rendered simulation information 314. Specifically, in some implementations, the pre-generated traffic animations 208 can generally indicate the behavior of the set of vehicles to be animated traversing the three-dimensional representation of the transportation segment. For example, the pre-generated traffic animations 208 can indicate starting positions, ending positions, vehicle types, etc. for each of the vehicles to be animated and rendered.

The rendered simulation information 314 can visually depict the objects indicated by the selected object information 322 traversing a three-dimensional representation of the transportation segments. For example, the rendered simulation information 314 may be or otherwise include video data that depicts the three-dimensional representation from a particular viewpoint. For another example, the rendered simulation information 314 may be or otherwise include Augmented Reality/Virtual Reality (AR/VR) data that depicts the three-dimensional representation within an explorable AR/VR environment. The rendered simulation information 314 can be provided to a display module 338 of the user computing device 212 for display at a display device associated with the user computing device 212.

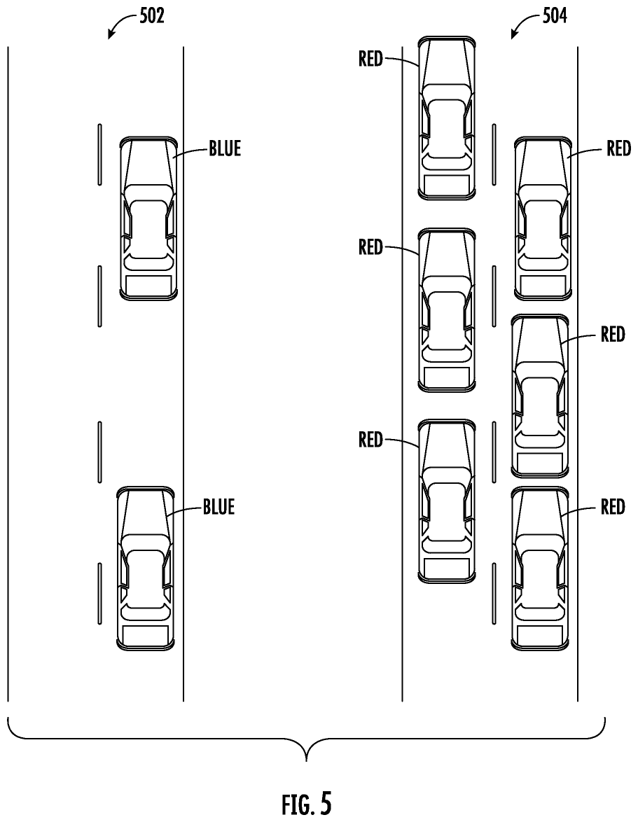

FIG. 5 depicts an example top-down view of animated vehicle objects traversing a three-dimensional representation of a transportation segment according to some implementations of the present disclosure. Specifically, pre-generated light-traffic animation 502 is an animation that animates vehicles traversing a transportation segment (e.g., a road, a portion of a road, a throughway, a highway, etc.) at a rate associated with light traffic conditions. In other words, the pre-generated light-traffic animation 502 can animate a quantity of vehicles traversing the transportation segment that is commonly associated with light traffic conditions (e.g., little to no delays caused by traffic). In addition, in some implementations, a pre-generated traffic animation can apply some sort of visual effect to animated objects, such as vehicles, that traverse the transportation segment to further indicate traffic conditions. To follow the depicted example, the pre-generated light-traffic animation 502 can apply a visual modifier, such as a blue color, to the vehicles traversing the segment to indicate a low degree of traffic.

Conversely, the pre-generated heavy-traffic animation 504 is an animation that animates vehicles traversing the same transportation segment at a rate associated with heavy traffic conditions. In other words, the pre-generated heavy-traffic animation 504 can animate a quantity of vehicles traversing the transportation segment that is commonly associated with moderate to heavy delays caused by traffic. Similarly, the pre-generated heavy-traffic animation 504 can apply a visual modifier, such as a red color, to the vehicles traversing the segment to indicate a low degree of traffic. In some implementations, the vehicles can be regionally specific. For example, if the transportation segment is located in London, the animations 502 and 504 can include double decker buses which are generally considered specific to London transportation segments.

It should be noted that the animations 502 and 504 are depicted in a top-down manner only to more clearly illustrate various implementations of the present disclosure. Rather, the animations 502 and 504 can depict a particular transportation segment in any manner, such as a 3D representation, a stylized 3D representation, a 2D representation (e.g., a “top-down” view), etc. Further, the animations 502 and 504 can apply any type or manner of visual effect to the objects traversing a segment to indicate traffic conditions. For example, rather than a color, a particular texture (e.g., a “flames” texture for a heavy degree of traffic, etc.), a highlighting effect, etc. may be applied to the animations 502 and 504.

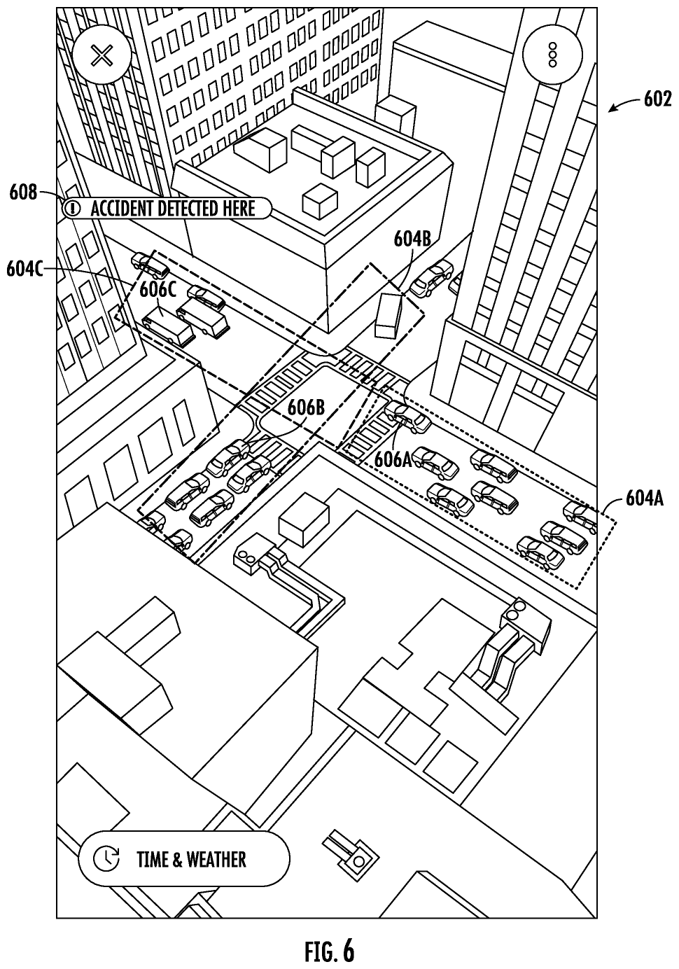

FIG. 6 depicts an example view of a three-dimensional representation of a transportation segment in which animated vehicle objects traverse the transportation segment according to some implementations of the present disclosure. Specifically, rendering 602 can be video data that depicts a view of a three-dimensional representation of two transportation segments 604A, 604B, and 604C. The transportation segments 604A and 604B can be contiguous segments of a city road, and transportation segment 604C can intersect the road formed by contiguous transportation segments 604A and 604B. The rendering 602 can further depict vehicles 606A-606C (generally, vehicles 606) traversing the transportation segments 604A-604C (generally, transportation segments 604).

It should be noted that, although not depicted, the rendering 602 can also depict current or predicted weather conditions for the transportation segments 604. For example, if it is currently raining at the transportation segment 604, the rendering 602 can depict rain falling within the simulated three-dimensional environment while the vehicles traverse the segment.

As each of the transportation segments 604A-604C are separate, real-time traffic speed information can be retrieved for each of the transportation segments 604C to accurately depict traffic conditions within each segment. To follow the depicted example, assume that simulation information, and/or real-time traffic information, indicates low traffic conditions (i.e., “free flow” traffic conditions) for transportation segment 604A, moderate traffic conditions for transportation segment 604B, and heavy traffic conditions for transportation segment 604C.

The traffic conditions can be visually indicated to the user by applying a visual modifier to the vehicles 606 that is visually representative of the real-time traffic conditions. For example, as the traffic conditions for the transportation segment 604A are light, vehicles traversing the transportation segment such as vehicle 606A can be colored green. For another example, as the traffic conditions for the transportation segment 604B are moderate, vehicles traversing the transportation segment such as vehicle 606A can be colored yellow. For yet another example, as the traffic conditions for the transportation segment 604C are heavy, vehicles traversing the transportation segment such as vehicle 606C can be colored red. Alternatively, some visual modifier other than color can be applied to the vehicles 606 to indicate the real-time traffic conditions (e.g., a texture, etc.).

The rendering 602 can also include annotations, such as those inserted by annotator 336 described with regards to FIG. 3. To follow the depicted example, the rendering 602 can depict annotation element 608. The annotation element 608 can include an icon and/or textual indication of the cause of the heavy traffic conditions for the transportation segment 604C.

It should be noted that the three-dimensional simulation of the environment that includes the transportation segments 604 can be rendered using any type or manner of conventional rendering technique. For example, the three-dimensional simulation of the environment can be rendered by applying textures to a three-dimensional mesh representation of the environment. For another example, the three-dimensional simulation of the environment can be rendered at least in part using a machine-learned model (e.g., a NeRF model, etc.) trained to learn an implicit representation of the environment and/or geographic area that includes the transportation segments. In some implementations, such a model can be trained using high-definition imaging information that depicts the environment and/or geographic area (e.g., Light Detection and Ranging (LIDAR) data, etc.

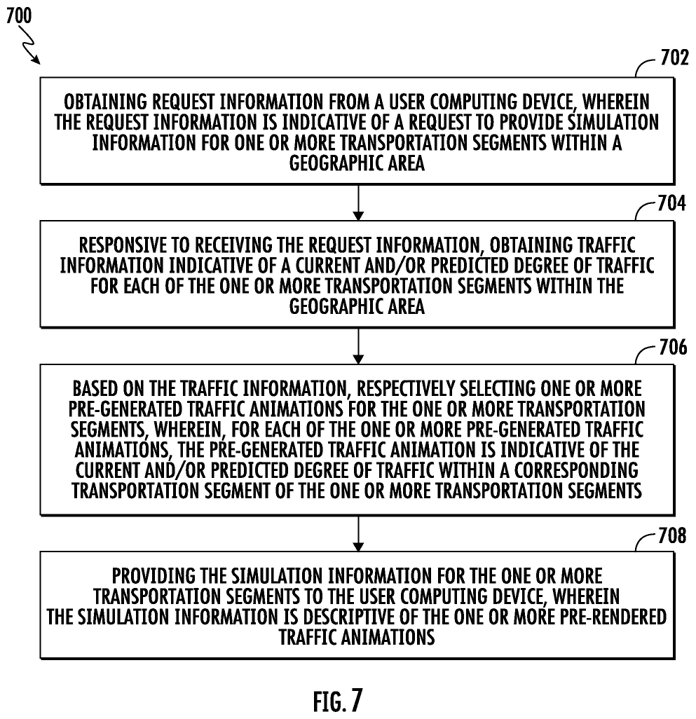

FIG. 7 depicts a flow chart diagram of an example method 700 to optimize provision of traffic flow simulations for representation of real-time traffic conditions according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain request information from a user computing device, wherein the request information is indicative of a request to provide simulation information for one or more transportation segments within a geographic area.

In some implementations, to obtain the traffic information indicative of the current and/or predicted degree of traffic, the computing system can obtain traffic information that is indicative of a high degree of current traffic for a first transportation segment of the one or more transportation segments within the geographic area. The traffic information can be indicative of a low degree of current traffic for a second transportation segment of the one or more transportation segments within the geographic area.

In some implementations, obtaining the traffic information can further include obtaining weather information indicative of weather conditions for each of the one or more transportation segments within the geographic area. Selecting the one or more pre-generated traffic animations for the one or more transportation segments can include, based on the traffic information and the weather information, respectively selecting the one or more pre-generated traffic animations for the one or more transportation segments. Each of the one or more pre-generated traffic animations can be indicative of the current and/or predicted degree of traffic, and the weather conditions, for the corresponding transportation segment of the one or more transportation segments.

At 704, the computing system can, responsive to receiving the request information, obtain traffic information indicative of a current and/or predicted degree of traffic for each of the one or more transportation segments within the geographic area.

At 706, the computing system can, based on the traffic information, respectively select one or more pre-generated traffic animations for the one or more transportation segments. For each of the one or more pre-generated traffic animations, the pre-generated traffic animation can be indicative of the current and/or predicted degree of traffic within a corresponding transportation segment of the one or more transportation segments.

In some implementations, the computing system can select a first pre-generated traffic animations for a first transportation segment of the one or more transportation segments. The first pre-generated traffic animation can depict vehicles traversing the transportation segment at a rate associated with the current and/or predicted degree of traffic for the first transportation segment. The first pre-generated traffic animation can further depict the heavy rain conditions.

In some implementations, to select the one or more pre-generated traffic animations, the computing system can select, based on the traffic information, a high-traffic pre-generated traffic animation from a plurality of pre-generated traffic animations for the first transportation segment. The high-traffic pre-generated traffic animation can depict vehicles traversing the first transportation segment at a rate associated with the high degree of current traffic, and the high-traffic pre-generated traffic animation can apply a first visual modifier to the vehicles indicative of the high degree of traffic. The computing system can select a low-traffic pre-generated traffic animation from a plurality of pre-generated traffic animations for the second transportation segment. The low-traffic pre-generated traffic animation can depict vehicles traversing the second transportation segment at a rate associated with the low degree of current traffic. The low-traffic pre-generated traffic animation can apply a second visual modifier to the vehicles that is indicative of the low degree of traffic.

At 708, the computing system can provide the simulation information for the one or more transportation segments to the user computing device, wherein the simulation information is descriptive of the one or more pre-generated traffic animations. In some implementations, providing the simulation information can include providing the simulation information for the one or more transportation segments to the user computing device with the one or more pre-generated traffic animations.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more computing devices, request information from a user computing device, wherein the request information is indicative of a request to provide simulation information for one or more transportation segments within a geographic area;
responsive to receiving the request information, obtaining, by the computing system, traffic information indicative of a current and/or predicted degree of traffic for each of the one or more transportation segments within the geographic area;
based on the traffic information, respectively selecting, by the computing system, one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments; and
providing, by the computing system, the simulation information for the one or more transportation segments to the user computing device, wherein the simulation information is descriptive of the one or more pre-generated traffic animations.

2. The computer-implemented method of claim 1, wherein obtaining the traffic information indicative of the current and/or predicted degree of traffic for each of the one or more transportation segments within the geographic area comprises:
obtaining, by the computing system, the traffic information, wherein the traffic information is indicative of a high degree of current traffic for a first transportation segment of the one or more transportation segments within the geographic area, and wherein the traffic information is indicative of a low degree of current traffic for a second transportation segment of the one or more transportation segments within the geographic area.

3. The computer-implemented method of claim 2, wherein selecting the one or more pre-generated traffic animations for the one or more transportation segments comprises:
selecting, by the computing system based on the traffic information, a high-traffic pre-generated traffic animation from a plurality of pre-generated traffic animations for the first transportation segment, wherein the high-traffic pre-generated traffic animation depicts vehicles traversing the first transportation segment at a rate associated with the high degree of current traffic, and wherein the high-traffic pre-generated traffic animation applies a first visual modifier to the vehicles indicative of the high degree of traffic.

4. The computer-implemented method of claim 3, wherein selecting the one or more pre-generated traffic animation for the one or more transportation segments comprises:
selecting, by the computing system based on the traffic information, a low-traffic pre-generated traffic animation from a plurality of pre-generated traffic animations for the second transportation segment, wherein the low-traffic pre-generated traffic animation depicts vehicles traversing the second transportation segment at a rate associated with the low degree of current traffic, and wherein the low-traffic pre-generated traffic animation applies a second visual modifier to the vehicles indicative of the low degree of traffic.

5. The computer-implemented method of claim 4, wherein the first visual modifier indicative of the high degree of traffic comprises a first color, and wherein the second visual modifier indicative of the low degree of traffic comprises a second color different than the first color.

6. The computer-implemented method of claim 1, wherein providing the simulation information comprises:
providing, by the computing system to the user computing device, the simulation information for the one or more transportation segments to the user computing device, wherein the simulation information comprises the one or more pre-generated traffic animations.

7. The computer-implemented method of claim 1, wherein providing the simulation information comprises:
providing, by the computing system to the user computing device, the simulation information for the one or more transportation segments to the user computing device, wherein the simulation information comprises rendering instructions configured to cause the user computing device to render the one or more pre-generated traffic animations.

8. The computer-implemented method of claim 1, wherein obtaining the traffic information indicative of the current and/or predicted degree of traffic for each of the one or more transportation segments within the geographic area further comprises:
obtaining weather information indicative of weather conditions for each of the one or more transportation segments within the geographic area; and
wherein selecting one or more pre-generated traffic animations for the one or more transportation segments comprises:
based on the traffic information and the weather information, respectively selecting, by the computing system, the one or more pre-generated traffic animations for the one or more transportation segments, wherein each of the one or more pre-generated traffic animations is indicative of the current and/or predicted degree of traffic, and the weather conditions, for the corresponding transportation segment of the one or more transportation segments.

9. The computer-implemented method of claim 8, wherein obtaining the weather information indicative of the weather conditions for each of the one or more transportation segments comprises:
obtaining, by the computing system, the weather information, wherein the weather information is indicative of heavy rain conditions for a first transportation segment of the one or more transportation segments; and
wherein selecting the one or more pre-generated traffic animations for the one or more transportation segments comprises:
based on the traffic information and the weather information, selecting, by the computing system, a first pre-generated traffic animations for a first transportation segment of the one or more transportation segments, wherein the first pre-generated traffic animation depicts vehicles traversing the transportation segment at a rate associated with the current and/or predicted degree of traffic for the first transportation segment, and wherein the first pre-generated traffic animation further depicts the heavy rain conditions.

10. A computing system, comprising:
one or more processors; and
one or more non-transitory computer-readable media that store instructions that, when executed by the one or more processors, cause the computing system to perform operations, the operations comprising:
obtaining request information from a user computing device, wherein the request information is indicative of a request to provide simulation information for one or more transportation segments within a geographic area;
responsive to receiving the request information, obtaining traffic information indicative of a current and/or predicted degree of traffic for each of the one or more transportation segments within the geographic area;
based on the traffic information, respectively selecting one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments; and
providing the simulation information for the one or more transportation segments to the user computing device, wherein the simulation information is descriptive of the one or more pre-generated traffic animations.

11. The computing system of claim 10, wherein obtaining the traffic information indicative of the current and/or predicted degree of traffic for each of the one or more transportation segments within the geographic area comprises:
obtaining the traffic information, wherein the traffic information is indicative of a high degree of current traffic for a first transportation segment of the one or more transportation segments within the geographic area, and wherein the traffic information is indicative of a low degree of current traffic for a second transportation segment of the one or more transportation segments within the geographic area.

12. The computing system of claim 11, wherein selecting the one or more pre-generated traffic animations for the one or more transportation segments comprises:
selecting, based on the traffic information, a high-traffic pre-generated traffic animation from a plurality of pre-generated traffic animations for the first transportation segment, wherein the high-traffic pre-generated traffic animation depicts vehicles traversing the first transportation segment at a rate associated with the high degree of current traffic, and wherein the high-traffic pre-generated traffic animation applies a first visual modifier to the vehicles indicative of the high degree of traffic.

13. The computing system of claim 12, wherein selecting the one or more pre-generated traffic animation for the one or more transportation segments comprises:
selecting, based on the traffic information, a low-traffic pre-generated traffic animation from a plurality of pre-generated traffic animations for the second transportation segment, wherein the low-traffic pre-generated traffic animation depicts vehicles traversing the second transportation segment at a rate associated with the low degree of current traffic, and wherein the low-traffic pre-generated traffic animation applies a second visual modifier to the vehicles indicative of the low degree of traffic.

14. The computing system of claim 13, wherein the first visual modifier indicative of the high degree of traffic comprises a first color, and wherein the second visual modifier indicative of the low degree of traffic comprises a second color different than the first color.

15. The computing system of claim 10, wherein providing the simulation information comprises:
providing, to the user computing device, the simulation information for the one or more transportation segments to the user computing device, wherein the simulation information comprises the one or more pre-generated traffic animations.

16. The computing system of claim 10, wherein providing the simulation information comprises:
providing, to the user computing device, the simulation information for the one or more transportation segments to the user computing device, wherein the simulation information comprises rendering instructions configured to cause the user computing device to render the one or more pre-generated traffic animations.

17. The computing system of claim 10, wherein obtaining the traffic information indicative of the current and/or predicted degree of traffic for each of the one or more transportation segments within the geographic area further comprises:
obtaining weather information indicative of weather conditions for each of the one or more transportation segments within the geographic area; and
wherein selecting one or more pre-generated traffic animations for the one or more transportation segments comprises:
based on the traffic information and the weather information, respectively selecting the one or more pre-generated traffic animations for the one or more transportation segments, wherein each of the one or more pre-generated traffic animations is indicative of the current and/or predicted degree of traffic, and the weather conditions, for the corresponding transportation segment of the one or more transportation segments.

18. The computing system of claim 17, wherein obtaining the weather information indicative of the weather conditions for each of the one or more transportation segments comprises:
obtaining the weather information, wherein the weather information is indicative of heavy rain conditions for a first transportation segment of the one or more transportation segments; and
wherein selecting the one or more pre-generated traffic animations for the one or more transportation segments comprises:
based on the traffic information and the weather information, selecting a first pre-generated traffic animations for a first transportation segment of the one or more transportation segments, wherein the first pre-generated traffic animation depicts vehicles traversing the transportation segment at a rate associated with the current and/or predicted degree of traffic for the first transportation segment, and wherein the first pre-generated traffic animation further depicts the heavy rain conditions.

19. One or more non-transitory computer-readable media that store instructions that, when executed by one or more processors, cause the one or more processors to perform operations, the operations comprising:
obtaining request information from a user computing device, wherein the request information is indicative of a request to provide simulation information for one or more transportation segments within a geographic area;
responsive to receiving the request information, obtaining traffic information indicative of a current and/or predicted degree of traffic for each of the one or more transportation segments within the geographic area;
based on the traffic information, respectively selecting one or more pre-generated traffic animations for the one or more transportation segments, wherein, for each of the one or more pre-generated traffic animations, the pre-generated traffic animation is indicative of the current and/or predicted degree of traffic within a corresponding transportation segment of the one or more transportation segments; and
providing the simulation information for the one or more transportation segments to the user computing device, wherein the simulation information is descriptive of the one or more pre-generated traffic animations.

20. The one or more non-transitory computer-readable media of claim 19, wherein obtaining the traffic information indicative of the current and/or predicted degree of traffic for each of the one or more transportation segments within the geographic area comprises:
obtaining the traffic information, wherein the traffic information is indicative of a high degree of current traffic for a first transportation segment of the one or more transportation segments within the geographic area, and wherein the traffic information is indicative of a low degree of current traffic for a second transportation segment of the one or more transportation segments within the geographic area.
